(19) United States
(12) Patent Application Publication
(10) Pub. No.: US 2025/0039941 A1
(43) Pub. Date: Jan. 30, 2025

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/777,558

(22) Filed: Jul. 19, 2024

(30) Foreign Application Priority Data
Jul. 27, 2023 (CN) 202310935203.9
Aug. 18, 2023 (CN) 202311048973.8

(51) Int. Cl. H04W 74/0833; H04L 5/00; H04W 74/08

(52) U.S. Cl. CPC H04W 74/0833; H04L 5/0051; H04W 74/0891

(57) ABSTRACT

A first receiver receives at least one of multiple reference signals; and selects a first reference signal, the first reference signal being one of the multiple reference signals; a first transmitter determines a target PRACH occasion group; and transmits a first random access preamble in the target PRACH occasion group; herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, each PRACH occasion group in the first PRACH occasion group set comprises K PRACH occasions.

### CROSS REFERENCE TO RELATED APPLICATIONS

This application claims the priority benefit of Chinese Patent Application No. 202310935203.9, filed on Jul. 27, 2023, and claims the priority benefit of Chinese Patent Application No. 202311048973.8, filed on Aug. 18, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

When a UE (i.e., User Equipment) wants to communicate with the network but there are no uplink shared channel or control channel resources available for transmission, or when the uplink transmission is in an unsynchronized state, the Physical random access channel (PRACH) is used for random access; using multiple PRACH occasions to transmit a random access preamble is a means of improving the uplink coverage.

### SUMMARY

For a UE configured with PRACH occasion groups, each of which includes multiple PRACH occasions, the determining of the PRACH occasion group for PRACH transmissions is a key problem that must be solved; in this regard, the present application discloses a solution. The present application can be applied to a variety of wireless communication scenarios, such as cellular networks, Vehicle-to-Everything (V2X), the Internet of Things (IoT), satellite-based communication networks, etc., and achieve similar technical results. Additionally, the adoption of a unified solution for various scenarios, including but not limited to cellular networks, V2X, IoT, and satellite-based communication networks, can contribute to the reduction of hardcore complexity and costs, or an enhancement in performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving at least one of multiple reference signals; and selecting a first reference signal, the first reference signal being one of the multiple reference signals; and
determining a target PRACH occasion group; and transmitting a first random access preamble in the target PRACH occasion group;
herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one embodiment, a problem to be solved in the present application includes: how to optimize the determination of the target PRACH occasion group.

In one embodiment, a problem to be solved in the present application includes: how to reduce the transmission delay or improve the transmission performance for PRACH transmissions performed using PRACH occasion groups.

In one embodiment, an advantage of the above method includes: increasing uplink coverage.

In one embodiment, an advantage of the above method includes: reducing the delay of a PRACH transmission performed using a PRACH occasion group, or, improving the success rate of a PRACH transmission performed using a PRACH occasion group.

In one embodiment, an advantage of the above method includes: enhancing the selection of the first node for a PRACH occasion group for sending a random access preamble, and enhancing the transmission performance of PRACH.

In one embodiment, an advantage of the above method includes: improving the efficiency of utilization of PRACH resources.

According to one aspect of the present application, the above method is characterized in that,
the first PRACH occasion group set depends on the first element.

According to one aspect of the present application, the above method is characterized in that,
each element in the first set is a PRACH occasion group, and each PRACH occasion group in the first set is mapped to the first reference signal, each PRACH occasion group in the first set comprising K PRACH occasions.

According to one aspect of the present application, the above method is characterized in that,
each element in the first set is a PRACH occasion, and each PRACH occasion in the first set is mapped to the first reference signal; PRACH occasion groups in the first PRACH occasion group set are all in the same period of the first type, and each PRACH occasion group in the first PRACH occasion group set has a starting PRACH occasion no earlier than the first element.

In one embodiment, an advantage of the above method includes: requiring lower effort for standardization and offering good compatibility.

In one embodiment, an advantage of the above method includes: ensuring that the first node has access to the uplink coverage gain resulting from PRACH transmissions using K PRACH occasions.

According to one aspect of the present application, the above method is characterized in that,
the multiple reference signals are multiple SSBs respectively.

According to one aspect of the present application, the above method is characterized in that,
the target PRACH occasion group is the PRACH occasion group selected from the first PRACH occasion group set.

According to one aspect of the present application, the above method is characterized in comprising:
receiving a first information block;
herein, the first information block comprises information indicative of a PRACH mask index; determination of the target PRACH occasion group depends on the first information block, each PRACH occasion in the target PRACH occasion group being a PRACH occasion indicated by the first information block.

In one embodiment, an advantage of the above method includes: streamlining the system design by utilizing the existing indication signaling of 3GPP for PRACH mask index to achieve indication of PRACH occasion groups.

In one embodiment, an advantage of the above method includes: helping improve performance of contention-free random access.

The present application provides a method in a second node for wireless communications, comprising:
transmitting multiple reference signals; and
receiving a first random access preamble in a target PRACH occasion group;
herein, a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

According to one aspect of the present application, the above method is characterized in that,
the first PRACH occasion group set depends on the first element.

According to one aspect of the present application, the above method is characterized in that,
each element in the first set is a PRACH occasion group, and each PRACH occasion group in the first set is mapped to the first reference signal, each PRACH occasion group in the first set comprising K PRACH occasions.

According to one aspect of the present application, the above method is characterized in that,
each element in the first set is a PRACH occasion, and each PRACH occasion in the first set is mapped to the first reference signal; PRACH occasion groups in the first PRACH occasion group set are all in the same period of the first type, and each PRACH occasion group in the first PRACH occasion group set has a starting PRACH occasion no earlier than the first element.

According to one aspect of the present application, the above method is characterized in that,
the multiple reference signals are multiple SSBs respectively.

According to one aspect of the present application, the above method is characterized in that,
the target PRACH occasion group is the PRACH occasion group selected from the first PRACH occasion group set.

According to one aspect of the present application, the above method is characterized in comprising:
transmitting a first information block;
herein, the first information block comprises information indicative of a PRACH mask index; determination of the target PRACH occasion group depends on the first information block, each PRACH occasion in the target PRACH occasion group being a PRACH occasion indicated by the first information block.

The present application provides a first node for wireless communications, comprising:
a first receiver, receiving at least one of multiple reference signals; and selecting a first reference signal, the first reference signal being one of the multiple reference signals; and
a first transmitter, determining a target PRACH occasion group; and transmitting a first random access preamble in the target PRACH occasion group;
herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

The present application provides a second node for wireless communications, comprising:
a second transmitter, transmitting multiple reference signals; and
a second receiver, receiving a first random access preamble in a target PRACH occasion group;
herein, a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram explaining elements in a first set according to one embodiment of the present application.

FIG. 7 illustrates a schematic diagram of relations among a first set, a first reference signal, a first PRACH occasion group set, a period of a first type and a first element according to one embodiment of the present application.

FIG. 8 illustrates a schematic diagram explaining a first PRACH occasion group set according to one embodiment of the present application.

FIG. 9 illustrates a schematic diagram explaining a first PRACH occasion group set according to one embodiment of the present application.

FIG. 10 illustrates a schematic diagram explaining a first information block according to one embodiment of the present application.

FIG. 11 illustrates a structure block diagram of a processing device in a first node according to one embodiment of the present application.

FIG. 12 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

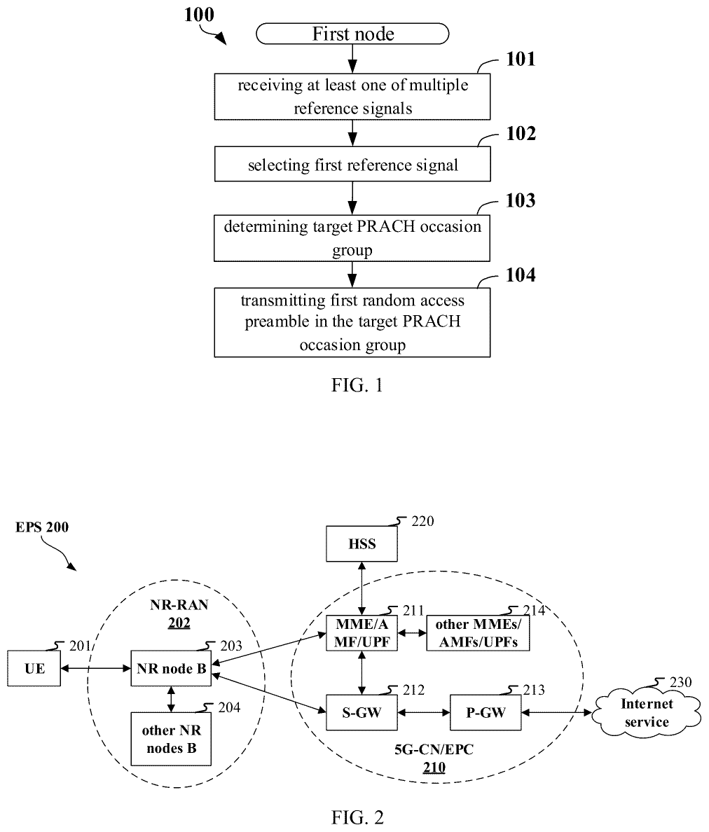

Embodiment 1 illustrates a flowchart of processing of a first node according to one embodiment of the present application, as shown in FIG. 1.

In Embodiment 1, the first node in the present application receives at least one of multiple reference signals in step 101; selects a first reference signal in step 102; and determines a target PRACH occasion group in step 103; and transmits a first random access preamble in the target PRACH occasion group in step 104.

In Embodiment 1, the first reference signal is one of the multiple reference signals; the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one embodiment, the multiple reference signals are multiple reference signals for contention-based Random Access, respectively.

In one embodiment, the multiple reference signals are multiple reference signals for contention-free Random Access, respectively.

In one embodiment, the multiple reference signals are multiple reference signals for beam failure recovery, respectively.

In one embodiment, the multiple reference signals are in a candidateBeamRSList.

In one embodiment, the multiple reference signals are multiple Synchronization Signal Blocks (SSBs), respectively.

In one embodiment, multiple reference signals are multiple Channel State Information Reference Signals (CSI-RS), respectively.

In one embodiment, the first node receives only part of the multiple reference signals.

In one embodiment, the first node itself determines which of the multiple reference signals are to be received.

In one embodiment, the first node receives each reference signal of the multiple reference signals.

In one embodiment, the first node receives at least 2 reference signals of the multiple reference signals and determines on its own the first reference signal from the at least 2 reference signals.

In one embodiment, the first node receives each reference signal of the multiple reference signals and randomly selects the first reference signal from the multiple reference signals with equal probability.

In one embodiment, the selection of the first reference signal depends on an estimation of channel quality.

In one embodiment, the selection of the first reference signal depends on Reference Signal Received Power (RSRP).

In one embodiment, the multiple reference signals are multiple SSBs respectively; if there exists at least one SSB that is in effect and whose corresponding Synchronization Signal-RSRP (SS-RSRP) is higher than a first threshold; the first reference signal is one SSB whose corresponding SS-RSRP is higher than the first threshold; otherwise, the first reference signal is an SSB determined by the first node itself; the first threshold is configurable.

In one embodiment, at least one reference signal of the multiple reference signals has an RSRP higher than a first threshold; the first reference signal is a reference signal among the multiple reference signals whose corresponding RSRP is higher than the first threshold; the first threshold is configurable.

In one subembodiment, which one of the multiple reference signals whose corresponding RSRP is higher than the first threshold is the first reference signal is determined by the first node itself.

In one subembodiment, the first node randomly selects the first reference signal from reference signals whose corresponding RSRPs are higher than the first threshold among the multiple reference signals.

In one subembodiment, the first reference signal is a reference signal having the highest RSRP among the multiple reference signals.

In one subembodiment, among the multiple reference signals there is no reference signal whose corresponding RSRP is not higher than the RSRP of the first reference signal and whose corresponding RSRP is higher than the first threshold.

In one embodiment, the RSRP of each one of the multiple reference signals is higher than a first threshold; the first threshold is configurable.

In one embodiment, the first node receives the multiple reference signals; the multiple reference signals are respectively multiple SSBs, each one of the multiple reference signals has an SS-RSRP that is above a first threshold and at least one of the multiple reference signals is available; the first threshold is configurable.

In one embodiment, which one of the multiple reference signals is the first reference signal is determined by the first node itself.

In one embodiment, the first node randomly selects the first reference signal from the multiple reference signals with equal probability.

In one embodiment, the first reference signal is a reference signal having the highest SS-RSRP among the multiple reference signals.

In one embodiment, the first reference signal is a reference signal having the lowest SS-RSRP among the multiple reference signals.

In one embodiment, the first threshold is configured by an RRC signaling.

In one embodiment, the first threshold is indicated by a rsrp-ThresholdSSB.

In one embodiment, the first threshold is indicated by a rsrp-ThresholdSSB-SUL.

In one embodiment, the first threshold is indicated by a rsrp-ThresholdCSI-RS.

In one embodiment, the first threshold is configured by a Medium Access Control layer Control Element (MAC CE).

In one embodiment, the first node receives at least one reference signal of the multiple reference signals and determines on its own the first reference signal.

In one embodiment, the determining a target PRACH occasion group comprises: determining K.

In one embodiment, K is one of 2, 4, or 8.

In one embodiment, K is no greater than 1024.

In one embodiment, K is configurable.

In one embodiment, K is indicated by an RRC signaling.

In one embodiment, K is indicated by a MAC CE.

In one embodiment, the first node itself determines K.

In one embodiment, a first range of values is predefined and the first node determines K by itself from the first range of values.

In one embodiment, a first range of values is configured by an RRC signaling and the first node determines K by itself from the first range of values.

In one embodiment, the determination of K is dependent on RSRP.

In one embodiment, multiple intervals are mapped one by one to multiple values in the first range of values, the multiple intervals do not overlap with each other; when the RSRP of the first reference signal falls within an interval, K is a value mapped to the interval in the first range of values.

In one embodiment, an advantage of the above method includes that the use of the RSRP improves the utilization of PRACH resources.

In one embodiment, the multiple intervals cover a range of values of the RSRP of the first reference signal.

In one embodiment, the multiple intervals are pre-defined.

In one embodiment, the multiple intervals are configured by RRC signaling.

In one embodiment, the first range of values comprises multiple positive integers.

In one embodiment, the first range of values comprises 2, 4, and 8.

In one embodiment, the first range of values is predefined.

In one embodiment, the first range of values is configured by RRC signaling.

In one embodiment, the first random access preamble is a random access preamble configured for PRACH transmission in a PRACH occasion group that includes K PRACH occasions.

In one embodiment, transmitting a PRACH in a PRACH occasion group means: transmitting a PRACH in each PRACH occasion included in this PRACH occasion group.

In one embodiment, the first node performs a single transmission of the first random access preamble in each PRACH occasion in the target PRACH occasion group.

In one embodiment, the first node transmits one repetition of the first random access preamble in each PRACH occasion in the target PRACH occasion group.

In one embodiment, the first node transmits at least a portion of the first random access preamble in each PRACH occasion in the target PRACH occasion group.

In one embodiment, the first random access preamble is mapped to the first reference signal according to a mapping relationship between a Random Access Preamble and a reference signal; the mapping relationship between the Random Access Preamble and the reference signal is configurable.

In one embodiment, the first random access preamble is configurable.

In one embodiment, the first random access preamble is configured to perform contention-free random access when the first reference signal is selected.

In one embodiment, the first node itself determines the first random access preamble.

In one embodiment, the first node randomly selects the first random access preamble, with equal probability, from among multiple random access preambles mapped to the first reference signal and configured for PRACH transmission in a PRACH occasion group comprising K PRACH occasions.

In one embodiment, the first node selects the first random access preamble, on its own, from among multiple random access preambles mapped to the first reference signal and configured for PRACH transmission in a PRACH occasion group comprising K PRACH occasions.

In one embodiment, the target PRACH occasion group is reserved for transmission of at least one random access preamble, the at least one random access preamble comprising the first random access preamble.

In one embodiment, each PRACH occasion group in the first PRACH occasion group set is reserved for transmission of at least one random access preamble, the at least one random access preamble comprising the first random access preamble.

In one embodiment, when a PRACH occasion group is configured for transmission of a random access preamble, the PRACH occasion group is reserved for the transmission of the random access preamble.

In one embodiment, when a PRACH occasion group is a candidate PRACH occasion group as a random access preamble is selected for a PRACH transmission, the PRACH occasion group is reserved for the transmission of the random access preamble.

In one embodiment, when a PRACH occasion is configured for transmission of a random access preamble, the PRACH occasion is reserved for the transmission of the random access preamble.

In one embodiment, when a PRACH occasion is a candidate PRACH occasion as a random access preamble is selected for a PRACH transmission, the PRACH occasion is reserved for the transmission of the random access preamble.

In one embodiment, when each PRACH occasion in a PRACH occasion group is reserved for transmission of a random access preamble, the PRACH occasion group is reserved for the transmission of the random access preamble.

In one embodiment, each element in the first set is reserved for transmission of at least one random access preamble, the at least one random access preamble comprising the first random access preamble.

In one embodiment, for each reference signal of the multiple reference signals, the first node is configured with at least one random access preamble.

In one embodiment, for an index of each reference signal of the multiple reference signals, the first node is configured with at least one random access preamble.

In one embodiment, when for an index of one reference signal of the multiple reference signals the first node is configured with a random access preamble, this random access preamble is a random access preamble for the one reference signal of the multiple reference signals.

In one embodiment, the first random access preamble is selected randomly with equal probability from more than one random access preamble configured for the first reference signal.

In one embodiment, a Random Access Preambles group B is not configured.

In one embodiment, the first random access preamble is a random access preamble in a Random Access Preambles group A.

In one embodiment, the first random access preamble is selected randomly with equal probability from more than one random access preamble associated with the first reference signal and the Random Access Preambles group A.

In one embodiment, the first random access preamble is selected randomly with equal probability from more than one random access preamble for the first reference signal and belonging to the Random Access Preambles group A.

In one embodiment, the first random access preamble is a random access preamble in a Random Access Preambles group B.

In one embodiment, the first random access preamble is selected randomly with equal probability from more than one random access preamble associated with the first reference signal and the Random Access Preambles group B.

In one embodiment, the first random access preamble is selected randomly with equal probability from more than one random access preamble for the first reference signal and belonging to the Random Access Preambles group B.

In one embodiment, the first element is determined by the first node itself from the first set.

In one embodiment, the first element is randomly selected by the first node from the first set.

In one embodiment, each element in the first set is a PRACH occasion group comprising K PRACH occasions.

In one embodiment, each element in the first set is a PRACH occasion group comprising only K PRACH occasions.

In one embodiment, each element in the first set is a PRACH occasion.

In one embodiment, the first set is configurable.

In one embodiment, there are 2 elements in the first set that are present in different periods of the first type.

In one embodiment, each reference signal of the multiple reference signals is configured by RRC signaling to at least one PRACH occasion; a reference signal to which a PRACH occasion is mapped is: a reference signal configured to this PRACH occasion.

In one embodiment, the first reference signal is an SSB; when an index of the first reference signal is mapped to at least one PRACH occasion, the at least one PRACH occasion is each mapped to the first reference signal.

In one embodiment, the multiple reference signals are respectively multiple SSBs with different indexes; the index of each reference signal of the multiple reference signals is mapped to at least one PRACH occasion in accordance with a pre-defined order of mapping and the number of SSBs mapped to each PRACH occasion configured by the RRC signaling.

In one embodiment, the multiple reference signals are respectively multiple SSBs with different indexes; the indexes of the SSBs are mapped to PRACH occasions in the following order:
First, within a single PRACH occasion in an ascending order of the index of preamble; second, in an ascending order of the index of frequency resources of the frequency-multiplexed PRACH occasion; and then, in an ascending order of the index of time resources of the time-division-multiplexed PRACH occasion within the PRACH slot; and finally, in an ascending order of the index of the PRACH slot.

In one embodiment, a PRACH being transmitted in a PRACH occasion has Quasi co-location in the spatial domain with the reference signal to which this PRACH occasion is mapped.

In one embodiment, the target PRACH occasion set comprises K PRACH occasions.

In one embodiment, in the process of determining the target PRACH occasion group: the first node first determines the first element from the first set, and then selects a PRACH occasion group randomly with equal probability from the first PRACH occasion group set.

In one subembodiment, the target PRACH occasion group is the PRACH occasion group selected from the first PRACH occasion group set.

In one embodiment, an advantage of the above method includes: reducing algorithmic complexity in determining the target PRACH occasion group.

In one embodiment, in the process of determining the target PRACH occasion group: the first node first randomly selects one PRACH occasion group from the first PRACH occasion group set with equal probability, and then determines the first element from the first set.

In one subembodiment, the target PRACH occasion group is the first element.

In one subembodiment, each element in the first set is a PRACH occasion group, the first set comprising one PRACH occasion group being selected from the first PRACH occasion group set.

In one embodiment, the periods of the first type are configurable.

In one embodiment, the period of the first type comprises 2 association pattern periods.

In one embodiment, the period of the first type comprises 4 association pattern periods.

In one embodiment, the period of the first type comprises 8 association pattern periods.

In one embodiment, the number of association pattern periods included in one period of the first type is configurable.

In one embodiment, any 2 of the periods of the first type comprise the same number of association pattern periods.

In one embodiment, any 2 of the periods of the first type occupy the same duration.

In one embodiment, an association pattern period depends on a mapping relationship between multiple synchronization signals/physical broadcast channel (SS/PBCH) block indexes and multiple PRACH occasions.

In one embodiment, an association pattern period includes one or more association period(s) for the mapping between the SS/PBCH block indexes to the PRACH occasions.

In one embodiment, the pattern of mapping between SS/PBCH block indexes and PRACH occasions is repeated among different association pattern periods.

In one embodiment, the expression “the first PRACH occasion group set depends on a period of the first type” means that the PRACH occasion groups in the first PRACH occasion group set are all in the same period of the first type.

In one embodiment, the determination of the first PRACH occasion group set is dependent on a period of the first type and the PRACH occasion groups in the first PRACH occasion group set are all in the same period of the first type.

In one embodiment, there are 2 PRACH occasions in the first PRACH occasion group set being respectively in 2 association pattern periods in the same period of the first type.

In one embodiment, the number of PRACH occasions included in the first PRACH occasion group set is limited to be no greater than the number of PRACH occasions that are mapped to the first reference signal in one period of the first type.

In one embodiment, the first PRACH occasion group set depends on the first element.

In one embodiment, the first PRACH occasion group set is related to a period of the first type where the first element is present.

In one embodiment, a period of the first type where the first element is present is one period of the first type that includes all time-domain resources occupied by the first element.

In one embodiment, a period of the first type where one PRACH occasion is present is one period of the first type including all time-domain resources occupied by the one PRACH occasion.

In one embodiment, a period of the first type where one PRACH occasion group is present is one period of the first type that includes all time-domain resources occupied by each PRACH occasion in the one PRACH occasion group.

In one embodiment, a target period is a period of the first type where the first element is present, and a period of the first type where any PRACH occasion group in the first PRACH occasion group set is present is not earlier than the target period.

In one embodiment, a target period is a period of the first type where the first element is present, the first PRACH occasion group set comprising PRACH occasion groups in the target period.

In one embodiment, a target period is a period of the first type where the first element is present, the first PRACH occasion group set comprising all available PRACH occasion groups in the target period.

In one embodiment, a target period is a period of the first type where the first element is present, the first PRACH occasion group set comprising only part of available PRACH occasion groups in the target period.

In one embodiment, a target period is a period of the first type where the first element is present, and each PRACH occasion group in the first PRACH occasion group set is an available PRACH occasion group in the target period.

In one embodiment, a target period is a period of the first type where the first element is present, and each PRACH occasion group in the first PRACH occasion group set is a PRACH occasion group in the target period.

In one embodiment, an advantage of the above method includes that the transmission delay for PRACH is reduced.

In one embodiment, a target period is a first one period of the first type that follows the period of the first type where the first element is present, and each PRACH occasion group in the first PRACH occasion group set is a PRACH occasion group in the target period.

In one embodiment, all elements of the first set are in the same period of the first type.

In one embodiment, for a PRACH occasion group that is mapped to the first reference signal, each PRACH occasion included is mapped to the first reference signal.

In one embodiment, when each PRACH occasion included in a PRACH occasion group is mapped to the first reference signal, this PRACH occasion group is mapped to the first reference signal.

In one embodiment, there is at least one PRACH occasion group that includes only K PRACH occasions and at least one PRACH occasion group that includes more than K PRACH occasions in the first PRACH occasion group set.

In one embodiment, an advantage of the above method includes: increasing efficiency of utilization of the PRACH occasion group including more than K PRACH occasions.

In one embodiment, an advantage of the above method includes: balancing the coverage effect of the uplink and the utilization efficiency of the PRACH resources.

In one embodiment, each PRACH occasion group in the first PRACH occasion group set is composed of K PRACH occasions.

In one embodiment, time-frequency resources occupied by a PRACH occasion are configurable.

In one embodiment, PRACH occasion groups in the first PRACH occasion group set are all in the same period of the first type.

In one embodiment, the first PRACH occasion group set comprises at least one PRACH occasion group.

In one embodiment, the first PRACH occasion group set comprises multiple PRACH occasion groups.

In one embodiment, when the first PRACH occasion group set comprises only one PRACH occasion group, the expression “randomly selecting one PRACH occasion group from the first PRACH occasion group set with equal probability” means that the unique PRACH occasion group in the first PRACH occasion group set is selected.

In one embodiment, which PRACH occasions are included in a PRACH occasion group is configurable.

In one embodiment, the time-frequency position of a starting PRACH occasion of a PRACH occasion group is configurable.

In one embodiment, all PRACH occasions included in a PRACH occasion group have a same index.

In one embodiment, all PRACH occasions in a PRACH occasion group are mapped to a same SSB.

In one embodiment, between an earliest PRACH occasion and a latest PRACH occasion in a PRACH occasion group: there does not exist a PRACH occasion that does not overlap in time domain with both the earliest PRACH occasion and the latest PRACH occasion in the PRACH occasion group and is mapped to the same SSB to which all PRACH occasions in the PRACH occasion group are mapped.

In one embodiment, a PRACH occasion group may span multiple association pattern periods.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the gNB203 corresponds to the second node in the present application.

In one embodiment, the UE 201 corresponds to the first node in the present application, and the gNB203 corresponds to the second node in the present application.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

### Embodiment 3

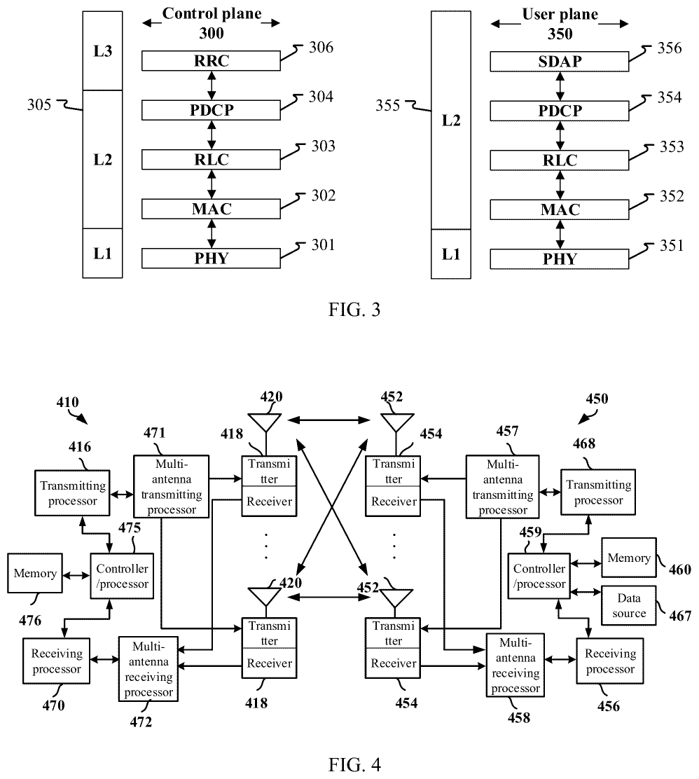

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC sublayer 306.

In one embodiment, the first random access preamble in the present application is generated by the PHY 301.

In one embodiment, the multiple reference signals in the present application are generated by the PHY 301.

### Embodiment 4

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also responsible for a retransmission of a lost packet, and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also in charge of a retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a relay node.

In one subembodiment, the first node is a UE, and the second node is a base station.

In one subembodiment, the first node is a relay node, and the second node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives at least one of multiple reference signals; and selects a first reference signal, the first reference signal being one of the multiple reference signals; and determines a target PRACH occasion group; and transmits a first random access preamble in the target PRACH occasion group; herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one subembodiment, the second communication device 450 corresponds to the first node in the present application.

In one embodiment, the second communication device 450 comprises a memory that stores a computer readable instruction program. The computer readable instruction program generates actions when executed by at least one processor. The actions include: receiving at least one of multiple reference signals; and selecting a first reference signal, the first reference signal being one of the multiple reference signals; and determining a target PRACH occasion group; and transmitting a first random access preamble in the target PRACH occasion group; herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one subembodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits multiple reference signals; and receives a first random access preamble in a target PRACH occasion group; herein, a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one subembodiment, the first communication device 410 corresponds to the second node in the present application.

In one embodiment, the first communication device 410 comprises a memory that stores a computer readable instruction program. The computer readable instruction program generates actions when executed by at least one processor. The actions include: transmitting multiple reference signals; and receiving a first random access preamble in a target PRACH occasion group; herein, a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the first information block in the present application.

In one embodiment, at least one of the antenna 420, the transmitter 418, the multi-antenna transmitting processor 471, the transmitting processor 416, the controller/processor 475 or the memory 476 is used for transmitting the first information block in the present application.

In one embodiment, at least one of the antenna 452, the receiver 454, the multi-antenna receiving processor 458, the receiving processor 456, the controller/processor 459, the memory 460, or the data source 467 is used for receiving at least one of the multiple reference signals in the present application.

In one embodiment, at least one of the antenna 420, the transmitter 418, the multi-antenna transmitting processor 471, the transmitting processor 416, the controller/processor 475 or the memory 476 is used for transmitting at least one of the multiple reference signals in the present application.

In one embodiment, at least one of the antenna 452, the receiver 454, the multi-antenna receiving processor 458, the receiving processor 456, the controller/processor 459, the memory 460, or the data source 467 is used for selecting the first reference signal in the present application.

In one embodiment, at least one of the antenna 452, the transmitter 454, the multi-antenna transmitting processor 457, the transmitting processor 468, the controller/processor 459, the memory 460 or the data source 467 is used for determining the target PRACH occasion group in the present application.

In one embodiment, at least one of the antenna 452, the transmitter 454, the multi-antenna transmitting processor 457, the transmitting processor 468, the controller/processor 459, the memory 460, or the data source 467 is used for transmitting the first random access preamble of the present application in the target PRACH occasion group of the present application.

In one embodiment, at least one of the antenna 420, the receiver 418, the multi-antenna receiving processor 472, the receiving processor 470, the controller/processor 475 or the memory 476 is used for receiving the first random access preamble of the present application in the target PRACH occasion group of the present application.

### Embodiment 5

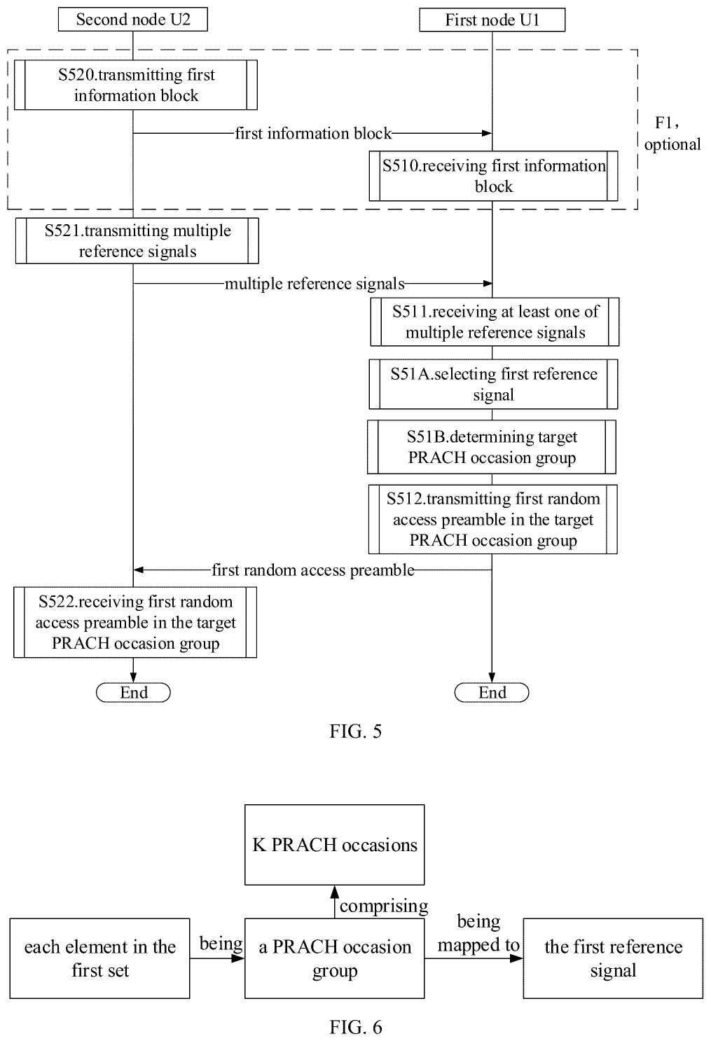

Embodiment 5 illustrates a flowchart of signal transmission according to one embodiment of the present application, as shown in FIG. 5. In FIG. 5, a first node U1 and a second node U2 are in communications via an air interface. In FIG. 5, steps marked by the dotted-line frame box F1 are optional.

The first node U1 receives a first information block in step S510; receives at least one of multiple reference signals in step S511; selects a first reference signal in step S51A; and determines a target PRACH occasion group in step S51B; and transmits a first random access preamble in the target PRACH occasion group in step S512.

The second node U2 transmits a first information block in step S520; transmits multiple reference signals in step S521; and receives a first random access preamble in the target PRACH occasion group in step S522.

In Embodiment 5, the multiple reference signals are multiple SSBs respectively, and the first reference signal is one of the multiple reference signals; the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type; the target PRACH occasion group is the PRACH occasion group selected from the first PRACH occasion group set; each element in the first set is a PRACH occasion, and each PRACH occasion in the first set is mapped to the first reference signal; the first PRACH occasion group set depends on the first element; PRACH occasion groups in the first PRACH occasion group set are all in the same period of the first type, and each PRACH occasion group in the first PRACH occasion group set has a starting PRACH occasion no earlier than the first element.

In one subembodiment of Embodiment 5, the first information block comprises information indicative of a PRACH mask index; determination of the target PRACH occasion group depends on the first information block, each PRACH occasion in the target PRACH occasion group being a PRACH occasion indicated by the first information block.

In one embodiment, the first node U1 is the first node in the present application.

In one embodiment, the second node U2 is the second node in the present application.

In one embodiment, the first node U1 is a UE.

In one embodiment, the second node U2 is a base station.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 includes a radio interface between a base station and a UE.

In one embodiment, an air interface between the second node U2 and the first node U1 includes a radio interface between a satellite device and a UE.

In one embodiment, an air interface between the second node U2 and the first node U1 includes a radio interface between a relay device and a UE.

In one embodiment, steps marked by the dotted-line box F1 exist.

In one embodiment, steps marked by the dotted-line box F1 do not exist.

### Embodiment 6

Embodiment 6 illustrates a schematic diagram explaining elements in a first set according to one embodiment of the present application, as shown in FIG. 6.

In Embodiment 6, each element in the first set is a PRACH occasion group, and each PRACH occasion group in the first set is mapped to the first reference signal, each PRACH occasion group in the first set comprising K PRACH occasions.

In one embodiment, the statement “determining a first element from a first set” comprises that the first element is a next available PRACH occasion group in the first set.

In one embodiment, the first element is a next available PRACH occasion group in the first set.

In one embodiment, an advantage of the above method includes that the transmission delay for PRACH is reduced.

In one embodiment, a starting PRACH occasion of the next available PRACH occasion group in the first set is no later than a starting PRACH occasion of any of available PRACH occasion groups in the first set.

In one embodiment, each PRACH occasion group in the first set of PRACH occasion group has a starting PRACH occasion no earlier than the first element.

In one embodiment, an advantage of the above method includes: ensuring that the first node has access to the uplink coverage gain resulting from PRACH transmissions using K PRACH occasions.

In one embodiment, a starting PRACH occasion of a PRACH occasion group is a first PRACH occasion in this PRACH occasion group.

In one embodiment, a starting PRACH occasion of a PRACH occasion group is a PRACH occasion that occupies the earliest time-domain resources in this PRACH occasion group.

In one embodiment, a starting PRACH occasion of a PRACH occasion group is a PRACH occasion with the earliest start time in this PRACH occasion group.

In one embodiment, a starting PRACH occasion of a PRACH occasion group is a PRACH occasion with the earliest end time in this PRACH occasion group.

In one embodiment, in this application, any 2 PRACH occasions in a PRACH occasion group do not overlap in the time domain.

In one embodiment, an advantage of the above method includes: reducing the complexity of the system design.

In one embodiment, when a start of one PRACH occasion is not later than a start of another PRACH occasion, the one PRACH occasion is not later than the other PRACH occasion.

In one embodiment, when an end of one PRACH occasion is not later than an end of another PRACH occasion, the one PRACH occasion is not later than the other PRACH occasion.

In one embodiment, when a starting PRACH occasion of a PRACH occasion group including K PRACH occasions is after the UE has completed the preparation for transmitting a PRACH, this PRACH occasion group is an available PRACH occasion group.

In one embodiment, when a start of an earliest PRACH occasion of a PRACH occasion group including K PRACH occasions is later than an end time of the UE completing the preparation for transmitting a PRACH, this PRACH occasion group is an available PRACH occasion group.

In one embodiment, a given PRACH occasion group is any PRACH occasion group in the first set; when a starting PRACH occasion of the given PRACH occasion group is after the UE has completed the preparation for transmitting the PRACH, the given PRACH occasion group is an available PRACH occasion group.

In one embodiment, a given PRACH occasion group is any PRACH occasion group in the first set; when a start of the earliest PRACH occasion in the given PRACH occasion group is later than an end time of the UE completing the preparation for transmitting a PRACH, the given PRACH occasion group is an available PRACH occasion group.

In one embodiment, when all K PRACH occasions included in a PRACH occasion group can be used for performing PRACH transmission, this PRACH occasion group is an available PRACH occasion group.

In one embodiment, the preparation for transmitting a PRACH completed by the UE comprises: selection of the first reference signal.

In one embodiment, the preparation for transmitting a PRACH completed by the UE comprises: selection of the first random access preamble.

In one embodiment, the preparation for transmitting a PRACH completed by the UE comprises: selection of a Random Access Preambles group A or B.

In one embodiment, the preparation for transmitting a PRACH completed by the UE comprises: determination of the target PRACH occasion group.

### Embodiment 7

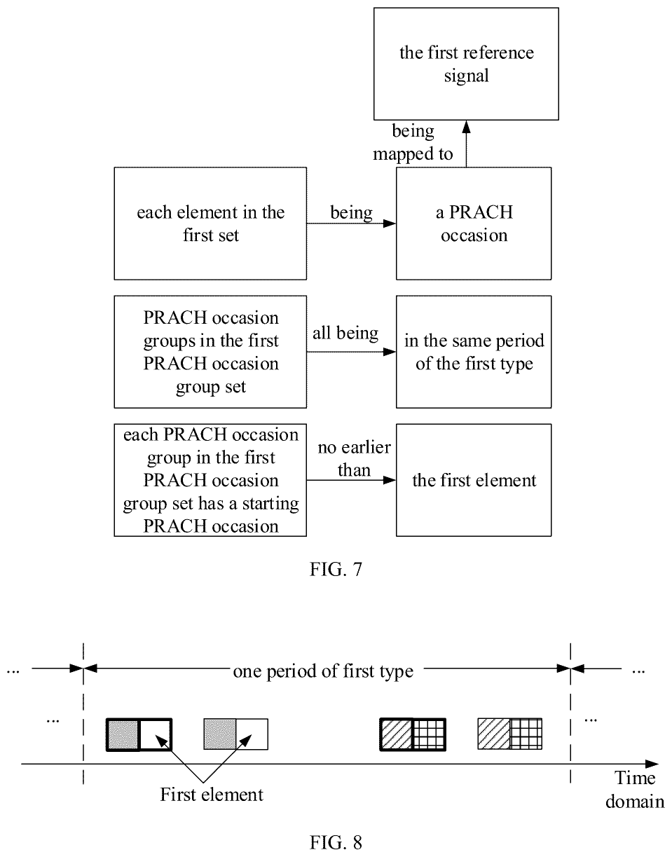

Embodiment 7 illustrates a schematic diagram of relations among a first set, a first reference signal, a first PRACH occasion group set, a period of a first type and a first element according to one embodiment of the present application, as shown in FIG. 7.

In Embodiment 7, each element in the first set is a PRACH occasion, and each PRACH occasion in the first set is mapped to the first reference signal; PRACH occasion groups in the first PRACH occasion group set are all in the same period of the first type, and each PRACH occasion group in the first PRACH occasion group set has a starting PRACH occasion no earlier than the first element.

In one embodiment, the first PRACH occasion group set depends on the first element.

In one embodiment, when a start of one PRACH occasion is not earlier than a start of another PRACH occasion, the one PRACH occasion is not earlier than the other PRACH occasion.

In one embodiment, when an end of one PRACH occasion is not earlier than an end of another PRACH occasion, the one PRACH occasion is not earlier than the other PRACH occasion.

In one embodiment, each element in the first set is a PRACH occasion, a first value is the sum of an index of the first element and a sorted index of a slot occupied by the first element in a system frame, and a second value is two times the index of the first element, and the first PRACH occasion group set comprises a PRACH occasion group indexed with the first value in the 8-th period of the first type following the period of the first type where the first element is present and a PRACH occasion group indexed with the second value.

In one embodiment, each element in the first set is a PRACH occasion.

In one embodiment, the first element is a next available PRACH occasion in the first set.

In one embodiment, an advantage of the above method includes that the transmission delay for PRACH is reduced.

In one embodiment, the next available PRACH occasion in the first set is no later than any of available PRACH occasions in the first set.

In one embodiment, each PRACH occasion group in the first set of PRACH occasion group has a starting PRACH occasion no earlier than the first element.

In one embodiment, an advantage of the above method includes that the transmission performance of the first random access preamble is guaranteed.

In one embodiment, a starting PRACH occasion of a PRACH occasion group is a first PRACH occasion in this PRACH occasion group.

In one embodiment, a starting PRACH occasion of a PRACH occasion group is a PRACH occasion that occupies the earliest time-domain resources in this PRACH occasion group.

In one embodiment, a starting PRACH occasion of a PRACH occasion group is a PRACH occasion with the earliest start time in this PRACH occasion group.

In one embodiment, a starting PRACH occasion of a PRACH occasion group is a PRACH occasion with the earliest end time in this PRACH occasion group.

In one embodiment, in this application, any 2 PRACH occasions in a PRACH occasion group do not overlap in the time domain.

In one embodiment, an advantage of the above method includes: reducing the complexity of the system design.

In one embodiment, when a start of one PRACH occasion is not later than a start of another PRACH occasion, the one PRACH occasion is not later than the other PRACH occasion.

In one embodiment, when an end of one PRACH occasion is not later than an end of another PRACH occasion, the one PRACH occasion is not later than the other PRACH occasion.

In one embodiment, when a PRACH occasion is after the UE has completed the preparation for transmitting a PRACH, this PRACH occasion is an available PRACH occasion.

In one embodiment, when a start of a PRACH occasion is later than an end time of the UE completing the preparation for transmitting a PRACH, this PRACH occasion is an available PRACH occasion.

In one embodiment, a given PRACH occasion is any PRACH occasion in the first set; when the given PRACH occasion is after the UE has completed the preparation for transmitting the PRACH, the given PRACH occasion is an available PRACH occasion.

In one embodiment, a given PRACH occasion is any PRACH occasion in the first set; when a start of the given PRACH occasion is later than an end time of the UE completing the preparation for transmitting the PRACH, the given PRACH occasion is an available PRACH occasion.

In one embodiment, a PRACH occasion is an available PRACH occasion when the PRACH occasion can be used to perform PRACH transmission.

In one embodiment, the preparation for transmitting a PRACH completed by the UE comprises: selection of the first reference signal.

In one embodiment, the preparation for transmitting a PRACH completed by the UE comprises: selection of the first random access preamble.

In one embodiment, the preparation for transmitting a PRACH completed by the UE comprises: selection of a Random Access Preambles group A or B.

In one embodiment, the preparation for transmitting a PRACH completed by the UE comprises: determination of the target PRACH occasion group.

### Embodiment 8

Embodiment 8 illustrates a schematic diagram explaining a first PRACH occasion group set according to one embodiment of the present application, as shown in FIG. 8. In FIG. 8, each box represents a PRACH occasion; 2 gray filled boxes represent a first PRACH occasion group, 2 blank boxes represent a second PRACH occasion group, 2 diagonally filled boxes represent a third PRACH occasion group, and 2 horizontally and vertically filled boxes represent a fourth PRACH occasion group; each bolded frame box represents a starting PRACH occasion in the corresponding PRACH occasion group.

In Embodiment 8, K is equal to 2; any of the first PRACH occasion group, the second PRACH occasion group, the third PRACH occasion group, and the fourth PRACH occasion group comprises 2 PRACH occasions, and these 4 PRACH occasion groups are in the same period of the first type; each element in the first set is a PRACH occasion group, the first element being determined as the second PRACH occasion group; the first PRACH occasion group set comprising the second PRACH occasion group, the third PRACH occasion group and the fourth PRACH occasion group, excluding the first PRACH occasion group.

In one embodiment, each PRACH occasion group in the first set of PRACH occasion group has a starting PRACH occasion no earlier than the first element.

### Embodiment 9

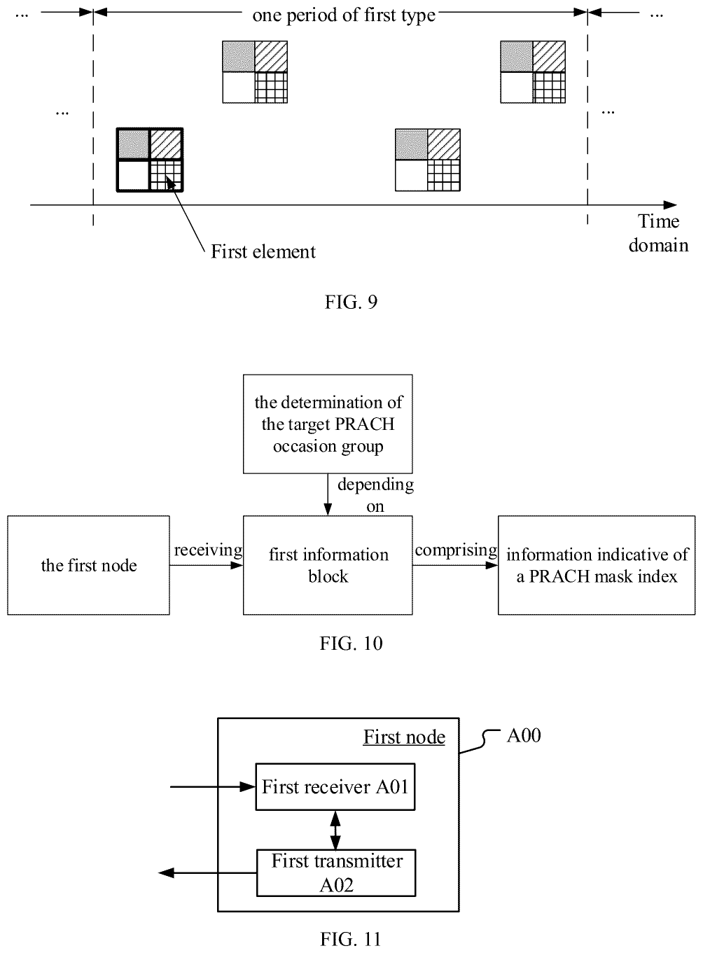

Embodiment 9 illustrates a schematic diagram explaining a first PRACH occasion group set according to one embodiment of the present application, as shown in FIG. 9. In FIG. 9, each box represents a PRACH occasion; 4 gray filled boxes represent a first PRACH occasion group, 4 blank boxes represent a second PRACH occasion group, 4 diagonally filled boxes represent a third PRACH occasion group, and 4 horizontally and vertically filled boxes represent a fourth PRACH occasion group; each bolded frame box represents a starting PRACH occasion in the corresponding PRACH occasion group.

In Embodiment 9, K is equal to 4; any of the first PRACH occasion group, the second PRACH occasion group, the third PRACH occasion group, and the fourth PRACH occasion group comprises 4 PRACH occasions, and these 4 PRACH occasion groups are in the same period of the first type; each element in the first set is a PRACH occasion, the first element being determined as the starting PRACH occasion of the fourth PRACH occasion group; the first PRACH occasion group set comprising the third PRACH occasion group and the fourth PRACH occasion group, excluding the first PRACH occasion group and the second PRACH occasion group.

In one embodiment, each PRACH occasion group in the first set of PRACH occasion group has a starting PRACH occasion no earlier than the first element.

In one embodiment, each element in the first set is a PRACH occasion; a target period is a period of the first type in which the first element is present; and if there is no PRACH occasion group in the target period that has a starting PRACH occasion not earlier than the first element and comprises K PRACH occasions, then the first PRACH occasion group set comprises a PRACH occasion group that is present in the first one period of the first type following the target period.

### Embodiment 10

Embodiment 10 illustrates a schematic diagram explaining a first information block according to one embodiment of the present application, as shown in FIG. 10.

In Embodiment 10, the first node receives a first information block; where the first information block comprises information indicative of a PRACH mask index; and the determination of the target PRACH occasion group depends on the first information block.

In one embodiment, an advantage of the above method includes: streamlining the system design by utilizing the existing indication signaling of 3GPP for PRACH mask index to achieve indication of PRACH occasion groups.

In one embodiment, an advantage of the above method includes: helping improve performance of contention-free random access.

In one embodiment, the first information block comprises an RRC layer parameter.

In one embodiment, the first information block is a ra-ssb-OccasionMasklndex.

In one embodiment, the first information block comprises a Physical downlink control channel (PDCCH) order (i.e., a PDCCH order).

In one embodiment, each PRACH occasion in the target PRACH occasion group is a PRACH occasion indicated by the first information block.

In one embodiment, the first set depends on the first information block.

In one embodiment, each element in the first set is a PRACH occasion group, and each PRACH occasion of each PRACH occasion group in the first set is a PRACH occasion indicated by the first information block.

In one subembodiment, when at least one PRACH occasion in a PRACH occasion group is not a PRACH occasion indicated by the first information block, this PRACH occasion group is not part of the first set.

In one embodiment, the first PRACH occasion group set is dependent on the first information block.

In one embodiment, each PRACH occasion of each PRACH occasion group in the first PRACH occasion group set is a PRACH occasion indicated by the first information block.

In one subembodiment, when at least one PRACH occasion in a PRACH occasion group is not a PRACH occasion indicated by the first information block, this PRACH occasion group is not part of the first PRACH occasion group set.

In one embodiment, a prerequisite for the first node to determine the target PRACH occasion group is that each PRACH occasion in the target PRACH occasion group is a PRACH occasion indicated by the first information block.

In one embodiment, an advantage of the above method includes: improving the effect of constraining the selection of PRACH occasion groups by the indicative signaling of the PRACH mask index, which facilitates system optimization.

In one embodiment, at least one PRACH occasion in the target PRACH occasion group is a PRACH occasion indicated by the first information block.

In one embodiment, the first set depends on the first information block.

In one embodiment, each element in the first set is a PRACH occasion group, and at least one PRACH occasion of each PRACH occasion group in the first set is a PRACH occasion indicated by the first information block.

In one subembodiment, when each PRACH occasion in a PRACH occasion group is not a PRACH occasion indicated by the first information block, this PRACH occasion group is not part of the first set.

In one embodiment, the first PRACH occasion group set is dependent on the first information block.

In one embodiment, at least one PRACH occasion of each PRACH occasion group in the first PRACH occasion group set is a PRACH occasion indicated by the first information block.

In one subembodiment, when each PRACH occasion in a PRACH occasion group is not a PRACH occasion indicated by the first information block, this PRACH occasion group is not part of the first PRACH occasion group set.

In one embodiment, a prerequisite for the first node to determine the target PRACH occasion group is that at least one PRACH occasion in the target PRACH occasion group is a PRACH occasion indicated by the first information block.

In one embodiment, an advantage of the above method includes: increasing the flexibility of the first node in selecting a PRACH occasion group.

In one embodiment, the first information block indicates at least one PRACH occasion, the at least one PRACH occasion being allowed to transmit a PRACH.

### Embodiment 11

Embodiment 11 illustrates a structure block diagram of a processing device in a first node, as shown in FIG. 11. In FIG. 11, a first node's processing device A00 comprises a first receiver A01 and a first transmitter A02.

In one embodiment, the first node A00 is a UE.

In one embodiment, the first node A00 is a relay node.

In one embodiment, the first node A00 is vehicle-mounted communication equipment.

In one embodiment, the first receiver A01 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver A01 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver A01 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver A01 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver A01 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter A02 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter A02 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter A02 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter A02 comprises at least the first three of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter A02 comprises at least the first two of the antenna 452, the transmitter 454, the multi-antenna transmitting processor 457, the transmitting processor 468, the controller/processor 459, the memory 460 and the data source 467 in FIG. 4 of the present application.

In one embodiment, the first receiver A01 receives at least one of multiple reference signals, and selects a first reference signal, the first reference signal being one of the multiple reference signals; the first transmitter A02 determines a target PRACH occasion group, and transmits a first random access preamble in the target PRACH occasion group; herein, the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one embodiment, the first PRACH occasion group set depends on the first element.

In one embodiment, each element in the first set is a PRACH occasion group, and each PRACH occasion group in the first set is mapped to the first reference signal, each PRACH occasion group in the first set comprising K PRACH occasions.

In one embodiment, each element in the first set is a PRACH occasion, and each PRACH occasion in the first set is mapped to the first reference signal; PRACH occasion groups in the first PRACH occasion group set are all in the same period of the first type, and each PRACH occasion group in the first PRACH occasion group set has a starting PRACH occasion no earlier than the first element.

In one embodiment, the multiple reference signals are multiple SSBs respectively.

In one embodiment, the target PRACH occasion group is the PRACH occasion group selected from the first PRACH occasion group set.

In one embodiment, the first receiver A01 receives a first information block; herein, the first information block comprises information indicative of a PRACH mask index; determination of the target PRACH occasion group depends on the first information block, each PRACH occasion in the target PRACH occasion group being a PRACH occasion indicated by the first information block.

### Embodiment 12

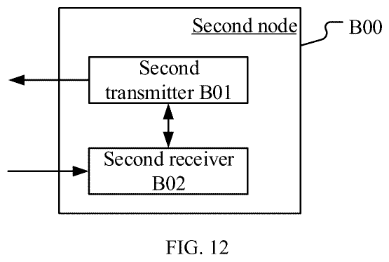

Embodiment 12 illustrates a structure block diagram a processing device in a second node according to one embodiment of the present application, as shown in FIG. 12. In FIG. 12, a second node's processing device B00 comprises a second transmitter B01 and a second receiver B02.

In one embodiment, the second node B00 is a base station.

In one embodiment, the second node B00 is satellite equipment.

In one embodiment, the second node B00 is a relay node.

In one embodiment, the second node B00 is one piece of test apparatus, test equipment or test instrument.

In one embodiment, the second transmitter B01 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter B01 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter B01 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter B01 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter B01 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver B02 comprises at least one of the antenna 420, the receiver 418, the multi-antenna receiving processor 472, the receiving processor 470, the controller/processor 475 or the memory 476 in FIG. 4 of the present application.

In one embodiment, the second receiver B02 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver B02 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver B02 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver B02 comprises at least the first two of the antenna 420, the receiver 418, the multi-antenna receiving processor 472, the receiving processor 470, the controller/processor 475 and the memory 476 in FIG. 4 of the present application.

In one embodiment, the second transmitter B01 transmits multiple reference signals; the second receiver B02 receives a first random access preamble in a target PRACH occasion group; herein, a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

In one embodiment, the first PRACH occasion group set depends on the first element.

In one embodiment, each element in the first set is a PRACH occasion group, and each PRACH occasion group in the first set is mapped to the first reference signal, each PRACH occasion group in the first set comprising K PRACH occasions.

In one embodiment, each element in the first set is a PRACH occasion, and each PRACH occasion in the first set is mapped to the first reference signal; PRACH occasion groups in the first PRACH occasion group set are all in the same period of the first type, and each PRACH occasion group in the first PRACH occasion group set has a starting PRACH occasion no earlier than the first element.

In one embodiment, the multiple reference signals are multiple SSBs respectively.

In one embodiment, the target PRACH occasion group is the PRACH occasion group selected from the first PRACH occasion group set.

In one embodiment, the second transmitter B01 transmits a first information block; herein, the first information block comprises information indicative of a PRACH mask index; determination of the target PRACH occasion group depends on the first information block, each PRACH occasion in the target PRACH occasion group being a PRACH occasion indicated by the first information block.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IoT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IoT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IoT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving at least one of multiple reference signals; and selecting a first reference signal, the first reference signal being one of the multiple reference signals; and
a first transmitter, determining a target PRACH occasion group; and transmitting a first random access preamble in the target PRACH occasion group;
wherein the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

2. The first node according to claim 1, characterized in that the first PRACH occasion group set depends on the first element.

3. The first node according to claim 1, characterized in that each element in the first set is a PRACH occasion group, and each PRACH occasion group in the first set is mapped to the first reference signal, each PRACH occasion group in the first set comprising K PRACH occasions.

4. The first node according to claim 1, characterized in that determination of K depends on RSRP.

5. The first node according to claim 1, characterized in that the multiple reference signals are multiple SSBs respectively.

6. The first node according to claim 1, characterized in that the target PRACH occasion group is the PRACH occasion group selected from the first PRACH occasion group set.

7. The first node according to claim 1, characterized in comprising:
the first receiver, receiving a first information block;
wherein the first information block comprises information indicative of a PRACH mask index; determination of the target PRACH occasion group depends on the first information block, each PRACH occasion in the target PRACH occasion group being a PRACH occasion indicated by the first information block.

8. A second node for wireless communications, comprising:
a second transmitter, transmitting multiple reference signals; and
a second receiver, receiving a first random access preamble in a target PRACH occasion group;
wherein a transmitting end of the first random access preamble selects a first reference signal and determines the target PRACH occasion group; the first reference signal is one of the multiple reference signals; the determining the target PRACH occasion group comprises: determining a first element from a first set; the first set comprises multiple elements, and each element in the first set comprises at least one PRACH occasion mapped to the first reference signal; the determining the target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

9. The second node according to claim 8, characterized in that the first PRACH occasion group set depends on the first element.

10. The second node according to claim 8, characterized in that each element in the first set is a PRACH occasion group, and each PRACH occasion group in the first set is mapped to the first reference signal, each PRACH occasion group in the first set comprising K PRACH occasions.

11. The second node according to claim 8, characterized in that the multiple reference signals are multiple SSBs respectively.

12. The second node according to claim 8, characterized in that the target PRACH occasion group is the PRACH occasion group selected from the first PRACH occasion group set.

13. The second node according to claim 8, characterized in comprising:
the second transmitter, transmitting a first information block;
wherein the first information block comprises information indicative of a PRACH mask index; determination of the target PRACH occasion group depends on the first information block, each PRACH occasion in the target PRACH occasion group being a PRACH occasion indicated by the first information block.

14. A method in a first node for wireless communications, comprising:
receiving at least one of multiple reference signals; and selecting a first reference signal, the first reference signal being one of the multiple reference signals; and
determining a target PRACH occasion group; and transmitting a first random access preamble in the target PRACH occasion group;
wherein the determining a target PRACH occasion group comprises: determining a first element from a first set; the first set comprises multiple elements, and each element in the first set comprises at least one PRACH occasion mapped to the first reference signal; the determining a target PRACH occasion group comprises: randomly selecting a PRACH occasion group from a first PRACH occasion group set with equal probability; each PRACH occasion group in the first PRACH occasion group set is mapped to the first reference signal, and each PRACH occasion group in the first PRACH occasion group set comprises K PRACH occasions, K being a positive integer greater than 1; a period of a first type includes multiple association pattern periods, and the first PRACH occasion group set depends on a period of the first type.

15. The method in the first node according to claim 14, characterized in that the first PRACH occasion group set depends on the first element.

16. The method in the first node according to claim 14, characterized in that each element in the first set is a PRACH occasion group, and each PRACH occasion group in the first set is mapped to the first reference signal, each PRACH occasion group in the first set comprising K PRACH occasions.

17. The method in the first node according to claim 14, characterized in that determination of K depends on RSRP.

18. The method in the first node according to claim 14, characterized in that the multiple reference signals are multiple SSBs respectively.

19. The method in the first node according to claim 14, characterized in that the target PRACH occasion group is the PRACH occasion group selected from the first PRACH occasion group set.

20. The method in the first node according to claim 14, characterized in comprising:
receiving a first information block;
wherein the first information block comprises information indicative of a PRACH mask index; determination of the target PRACH occasion group depends on the first information block, each PRACH occasion in the target PRACH occasion group being a PRACH occasion indicated by the first information block.
